(19) United States
(12) Patent Application Publication
(10) Pub. No.: US 2023/0351549 A1
(43) Pub. Date: Nov. 2, 2023

(54) ADAPTIVE TECHNOLOGY FOR REDUCING 3A ALGORITHM COMPUTATION COMPLEXITY

(71) Applicant: Intel Corporation, Santa Clara, CA (US)

(72) Inventors: Hongjiang ZHENG, Beijing (CN); Yu XIA, Beijing (CN); Yuanyuan WANG, Beijing (CN); Jifang XING, Beijing (CN); Ilya SISTER, Haifa (IL)

(73) Assignee: Intel Corporation, Santa Clara, CA (US)

(21) Appl. No.: 18/345,593

(22) Filed: Jun. 30, 2023

(30) Foreign Application Priority Data
Apr. 12, 2023 (WO) PCT/CN2023/087769

(51) Int. Cl. G06T 3/40

(52) U.S. Cl. CPC G06T 3/40

(57) ABSTRACT

Technology described herein provides for adapting statistics resolution for 3A algorithms. The technology is to analyze a scene from a plurality of input images to determine a stability score, determine a target imaging statistics resolution based on the stability score, and calculate, using imaging statistics corresponding to the target imaging statistics resolution, an auto exposure parameter and/or an auto white balance parameter. In one aspect, the technology is to generate a multi-scale statistics set including a plurality of sets of imaging statistics, select the target imaging statistics resolution from a predetermined set of resolutions, and select, from the plurality of sets of imaging statistics, a set of imaging statistics corresponding to the target imaging statistics resolution. In another aspect, the technology is to compute the target imaging statistics resolution based on the stability score and a maximum imaging statistics resolution for the computing device.

### CROSS-REFERENCE TO RELATED APPLICATIONS

This patent application claims the benefit of priority to International Patent Application No. PCT/CN2023/087769, filed on Apr. 12, 2023.

### TECHNICAL FIELD

Embodiments generally relate to digital media technology. More particularly, embodiments relate to reducing computational complexity of algorithms used for digital camera operation.

### BACKGROUND

The rise of digital cameras in phones and embedded devices has resulted in the trend that most people now rely on their smartphones for taking photographs. A set of control algorithms known as “3A”—auto focus (AF), auto exposure (AE), and auto white balance (AWB), along with statistics such as red/green/blue (RGB) components, histograms, focus value statistics, etc.—are a necessary component of digital camera systems. The 3A algorithms typically are to set proper control parameters for controlling the AE parameter via the camera sensor, controlling the AF parameter via the voice coil motor (VCM), and controlling the AWB parameter via the image signal processor (ISP). The 3A algorithms thus play an important role in obtaining better image quality, including sharpness, color accuracy, shading correction, etc.

The control parameters are calculated via the 3A algorithms based on variable imaging statistics per frame. There is a trade-off between the statistics resolution and image quality. For higher image quality, the 3A algorithms need statistics with more detailed information in order to obtain more precise results, which means more computation complexity. Further, trends in digital camera development, where pixels get smaller, or sensors get larger, lead to the same result—higher resolution with more information, all of which increases the computation complexity.

### BRIEF DESCRIPTION OF THE DRAWINGS

The various advantages of the embodiments will become apparent to one skilled in the art by reading the following specification and appended claims, and by referencing the following drawings, in which:

FIG. 1 provides a diagram illustrating a conventional 3A algorithm control flow for an image processing system for a typical camera imaging device;

FIGS. 2A-2C provide diagrams illustrating an adaptive technique to determine an imaging statistics resolution to be used in determining 3A statistics for 3A algorithms according to one or more embodiments;

FIGS. 3A-3B provide diagrams illustrating an alternative adaptive technique to determine an imaging statistics resolution to be used in determining 3A statistics for 3A algorithms according to one or more embodiments;

FIGS. 4A-4B provide flow diagrams illustrating an example method of determining auto exposure and auto white balance parameters for generating an output image according to one or more embodiments;

FIG. 5 is a block diagram of an example of a performance-enhanced computing system according to one or more embodiments; and

FIG. 6 is a block diagram illustrating an example semiconductor apparatus according to one or more embodiments.

### DESCRIPTION OF EMBODIMENTS

### Reducing 3A Algorithm Computation Complexity

Given development trends in digital camera technology, the 3A control algorithms must handle significant statistics data—particularly in variable conditions—when calculating the auto exposure (AE), auto white balance (AWB) and auto focus (AF) parameters in order to obtain the best image quality. If the calculations cannot be completed in one frame duration, the 3A algorithm output frequency cannot catch up with sensor frames per second (fps), which means the 3A algorithm results cannot be applied to the appropriate controls (e.g., via the sensor/ISP) in time. As a result, the image quality is negatively affected. For a steady state scenario, from a power saving perspective it is unnecessary to run 3A algorithms with full size statistics; rather it can be enough to use downscaled statistics without any image quality loss.

Previous approaches have used a technique that decreases the frame run rate of the 3A algorithms. To accomplish this, the prior approaches do not apply the 3A algorithms on each frame; instead, the 3A algorithm run rate is decreased from once every frame to once every multiple frame. While this technique does provide for reducing the CPU workload on computing the 3A algorithms, there are several disadvantages. For example, this technique cannot avoid heavy 3A algorithm computations with full statistic data. Further, the image quality (IQ) is variable and depends on use cases or the environment (which is variable). None of the conventional approaches consider adaptive techniques as described herein.

Technology described herein addresses the problem of the computational complexity of algorithms used for digital camera operation through adaptive methods. More particularly, embodiments provide an enhanced approach to reducing 3A algorithm computation complexity by adapting the resolution of statistics for the 3A algorithms based on dynamic scene analysis, without IQ loss. This enhanced approach can achieve high image quality with low 3A algorithm computation consumption while the camera device is running, and can also achieve power saving by reducing 3A algorithm computation complexity (e.g., when the scene is stable).

According to embodiments, the 3A algorithm camera control system is redesigned and includes extra computing blocks to reduce 3A algorithm computation complexity using an adaptive technique. In embodiments, the adaptive technique is applied each frame. According to embodiments, there are two alternative approaches to providing adaptive techniques for determining a target (e.g., best) resolution for imaging statistics for different scenarios, as follows:
(A) According to embodiments using either approach, the stability of the scene is analyzed based on statistics generated by the ISP hardware (HW); and
(B1) According to embodiments using the first approach, based on the scene stability, the algorithm adaptively chooses the best one of multi-scale statistics in a pyramid representation from the ISP hardware to calculate the AE, AWB and/or AF results; or
(B2) According to embodiments using the second approach, based on the scene stability, the algorithm adaptively calculates the best resolution of statistics and configures the corresponding settings in the ISP hardware to provide statistics for AE, AWB and/or AF calculations.

Using either of these approaches, in embodiments the imaging statistics are generated at a particular resolution to be used in running 3A algorithms to determine AE, AWB and/or AF parameters for an imaging device. The resolution level at which the statistics are calculated is related to the scene stability as follows:

| Scene Stability | Statistics | 3A Computation | |
|---|---|---|---|
| Level | Resolution | Level Resolution | IQ |
| High | Low | Low | High |
| Medium | Medium | Medium | High |
| Low | High | High | High |

The imaging statistics resolution can be computed based on a number of blocks from the input image, where a block can represent a number of pixels in the input image (as one example, a block can represent 36×36 pixels). For example, statistics can be computed over image blocks with a downscaling ratio of 1:16 (e.g., relative high resolution), 1:32 (e.g., relative medium resolution) or 1:64 (e.g., relative low resolution). Downscaling reduces the number of blocks needed for the calculations, and the downscaling ratio reflects (e.g., is a metric for) the imaging statistics resolution. For example, with a set of 16×16 blocks, downscaling at a ratio of 1:16 results in 4×4 blocks. Other selections for downscaling ratios (imaging statistics resolutions) are possible. Other metrics for imaging statistics resolution can be employed.

In all scenarios (dynamic/variable scenes and steady scenes), the system can adaptively change the 3A computation complexity according to the scenario similarity and stability. In one example with an environment having a relatively steady scene—including lux level, light source etc. (e.g., a video conference), the stability level (in this example) is ‘HIGH’ during 80% of the time. As a result, the system can maintain the computation complexity in low level for 80% of 3A algorithm frame calculations. In another example, in fast speed mode (e.g., 60 fps), the system can adapt the processing and still complete the 3A algorithm computations each frame (i.e., without skipping computations for any frames).

There are two main types of camera modules based on camera 3A control technology: universal serial bus (USB) camera modules and mobile industry processor interface (MIPI) camera modules. Devices with USB camera modules, differing from those with MIPI camera modules, typically have an internal integrated ISP and 3A algorithm flow for image capture and processing. Such camera modules output an RGB or YUV pixel frame to a host device through a USB bus.

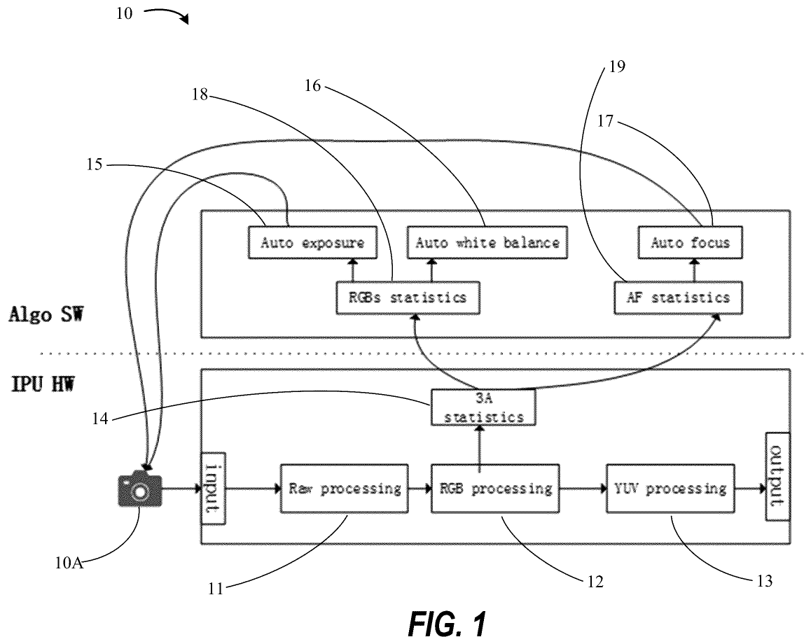

Regarding devices (such as, e.g., smartphones or other mobile phones) with MIPI camera modules, FIG. 1 provides a diagram illustrating a conventional 3A algorithm control flow 10 in the image processing system (e.g., image signal processor (ISP) or image processing unit (IPU)) for a typical device 10A (e.g., a smartphone or other mobile camera imaging device) having a MIPI camera module. The control flow 10 includes hardware operations involving IPU hardware and software operations running the 3A algorithms. IPU hardware modules include a raw processing module 11 to process raw input images from an imaging sensor, an RGB processing module 12 to produce RGB images from the output of the raw processing module 11, and a YUV processing module 13 to produce, from the RGB images, output image frames in a YUV (e.g., luminance or brightness (Y), blue projection (U) and red projection (V)) pixel format. A 3A statistics module 14 produces 3A statistics from an output of the RGB processing module 12 to be used for the 3A algorithms. The 3A statistics include RGB statistics 18 and AF statistics 19.

Software modules include an auto exposure module 15 to produce AE control parameters, and auto white balance module 16 to produce AWB control parameters, and an auto focus module 17 to produce AF control parameters. The auto exposure module 15 and the auto white balance module 16 receive input from RGB statistics 18, and the auto focus module 17 receives input from AF statistics 19.

According to embodiments, there are two alternative approaches to providing adaptive techniques for determining an appropriate (target/best) resolution for imaging statistics. Using these approaches in conjunction with IPU hardware (e.g., IPU hardware having features described herein with reference to FIG. 1), the imaging statistics are determined at a particular resolution to be used in determining 3A statistics when running 3A algorithms to determine AE, AWB and/or AF parameters for an imaging device. The target resolution generally increases when scene stability decreases, and the target resolution generally decreases when scene stability increases. For example, when the scene stability is relatively at the highest level (e.g., no motion, no lighting change, etc.) the target resolution is a low resolution which, in some embodiments, is the lowest statistics resolution that can be generated by the IPU hardware. As another example, when the scene stability is relatively at the lowest level (e.g., constant/rapid motion in the scene along with changing lighting conditions, etc.), the target resolution is a high resolution which, in some embodiments, is the highest statistics resolution that can be generated by the IPU hardware.

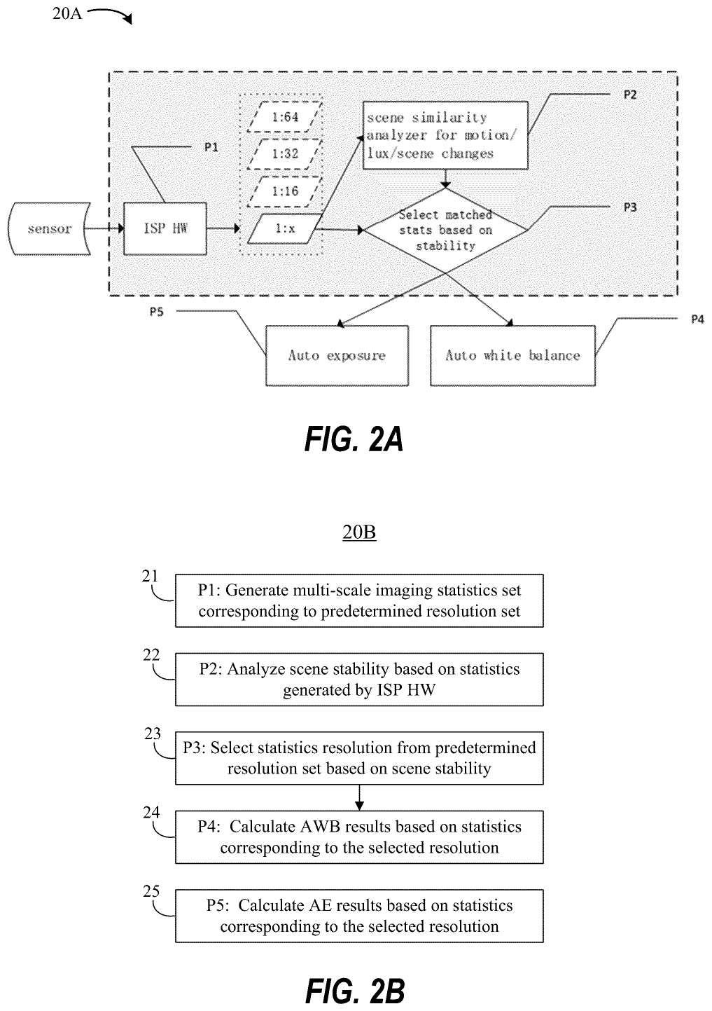

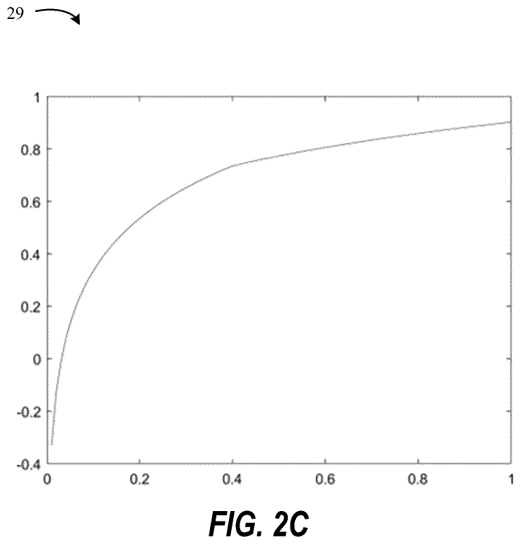

FIGS. 2A-2B provide diagrams illustrating an adaptive technique to determine an imaging statistics resolution for use in determining 3A statistics for computing 3A algorithms according to one or more embodiments, with reference to components and features described herein including but not limited to the figures and associated description. As shown in FIG. 2A, the diagram illustrates an adaptive technique 20A to determine an imaging statistics resolution to be used in determining 3A statistics when running 3A algorithms. The adaptive technique 20A operates by selecting imaging statistics corresponding to one of a set of preset resolutions based on scene stability. An imaging sensor (e.g., an imaging device or part of a camera/imaging device) provides input images to the ISP hardware, which generates a multi-scale set of imaging statistics corresponding to a set of predetermined resolutions, the predetermined resolutions corresponding to a set of downscaling ratios (such as, e.g., 1:64, 1:32 and 1:16). A scene stability analysis is conducted to determine a scene stability score. The scene stability score is used to select a target imaging statistics resolution or target resolution (e.g., a target downscaling ratio), based on the predetermined set of resolutions (e.g., predetermined downscaling ratios), to provide imaging statistics at the target resolution. The imaging statistics at the selected (i.e., target) resolution are used by the 3A algorithms to calculate one or more of the AE, AWB and/or AF parameters for the camera imaging device.

Turning now to FIG. 2B, the diagram illustrates an adaptive method 20B to determine an imaging statistics resolution and select imaging statistics for calculating AE/AWB parameters for the technique illustrated in FIG. 2A. The adaptive method 20B includes five illustrated processing blocks labeled P1 through P5 that correspond to labels P1 through P5 in FIG. 2A. A core portion of the method 20B (processing blocks labeled P1, P2 and P3) corresponds to three labels P1-P3 shown in the shaded block of FIG. 2A.

Illustrated processing block 21 (labeled P1) provides for generating a multi-scale imaging statistics set corresponding to a predetermined set of resolutions, after initializing the ISP hardware with a default statistics resolution configuration. Taking the RAW image from the imaging sensor as input, the ISP hardware (e.g., the 3A statistics module 14 in FIG. 1, already discussed) generates a set of multi-scale statistics. The multi-scale statistics set includes a plurality of sets of imaging statistics, each set of imaging statistics corresponding to a different resolution of the predetermined set of resolutions. For example, a multi-scale set of three different sets of statistics, each corresponding to a different resolution (e.g., a downscaling ratio such as 1:64, 1:32, or 1:16) from the predetermined set of resolutions (e.g., set of downscaling ratios such as 1:64, 1:32, and 1:16), are generated. In some embodiments, other resolutions (e.g. downscaling ratios) are used (e.g., where at least one of the downscaling ratios is other than 1:64, 1:32, or 1:16). In some embodiments, more or fewer than three different resolutions (e.g., downscaling ratios) are used.

Illustrated processing block 22 (labeled P2) provides for analyzing scene stability based on statistics generated by the ISP hardware. In embodiments, the statistics used in scene stability analysis are based on a statistics resolution selected in a prior iteration of processing block 23. A scene similarity analysis algorithm analyzes the scenes from the recent history (e.g., current frame and previous frame, past two frames, or past several frames, etc.) and calculates a stability score that reflects a relative stability for the scene. Multiple factors can impact the stability score, e.g., lux level, motion, light source, etc.

Analyzing scene similarity to determine a stability score can be performed using any one or more of a number of techniques. For example, in some embodiments a stability score is determined based on using a structural similarity index measure (SSIM) to measure the similarity (or differences) between two recent input images (or frames), such as, e.g., two images or frames in a sequence. As another example, in some embodiments a stability score is determined based on comparing the imaging statistics (e.g., as generated by the IPU/ISP) for two or more recent images (or frames) to measure the similarity (or differences) between the images (or frames), such as, e.g., two images or frames in a sequence (e.g., comparing imaging statistics for the current image or frame with imaging statistics for the previous image or frame). In the latter example, the use of imaging statistics for determining scene similarity is based on the premise that if a scene is stable, the pixels for the current frame and the previous frame will be the same (or nearly the same) such that the imaging statistics for each frame would also be the same (or nearly the same). Likewise, if the scene is not stable the pixels for the current frame and previous frame will be significantly different such that the imaging statistics for each frame would also be significantly different. In some embodiments, the generation of multi-scale statistics by the IPU is performed in parallel with (e.g., essentially at the same time as) the scene stability analysis, as the scene stability analysis is performed, e.g., by a central processing unit (CPU) or graphics processing unit (GPU).

Illustrated processing block 23 (labeled P3) provides for selecting a statistics resolution from the predetermined set of resolutions based on scene stability. Given the stability score from block 22 (P2), a provisional resolution (e.g., downscaling ratio) is calculated, e.g., representing an estimated best statistics resolution for the frame. Then according to a minimum distance rule, the best statistics ratio (e.g., best match) from the given predetermined (e.g., preset) statistics ratio set is selected (e.g., a selection among ratios 1:16, 1:32, 1:64, if these ratios are for the preset ratio set) as the target resolution. In embodiments, the statistics resolution (e.g., downscaling ratio) to be used in block 22 (P2) is updated based on the selection. That is, the next iteration of block 22 (P2) uses updated ratio scaled statistics (e.g., the selected statistics corresponding to the selected resolution) to calculate the stability score. The suggested formula is:

$$factor = \{ \begin{matrix}k * log ( score ) + a & when 0. < score \leq 0.4 \\ {score}^{γ} - δ & when 0.4 < score \leq 1.\end{matrix} \qquad EQ . 1 a$$

$$distance = arg {min}_{i ∈ \{ α \}} ( max ( factor , 0 ) - \frac{i}{max ( α )} ) \qquad EQ . 1 b$$

where:
score represents a stability score (normalized between 0 and 1)
distance represents a distance from a target ratio to a preset ratio
γ represents a tuning parameter (e.g. 0.2)
δ represents a conjunction of 2 curves
{α} represents a preset ratio set

Each of the constituent equations in EQ. 1a has an associated curve (e.g., factor vs score). Based on EQ. 1a, there is a pivot point when the score is equal to 0.4; that is, when the score is 0.4 each constituent equation of the set of equations in EQ. 1a should give the same result for factor, and the constituent curves should meet at the pivot point. Accordingly, the values of a, k, δ and γ are set based at least in part on the pivot point; also, these values can be set to establish characteristics of each constituent curve (e.g., slope, curvature, endpoints, etc.). For example, in embodiments the tuning parameter γ is used to determine or adjust the sensitivity of how quickly the factor changes when the score changes and is in the range 0.4 to 1.0.

For example, for a set of downscaling ratios 1:16, 1:32 and 1:64, the corresponding preset ratio set {α} is {16, 32, 64}, and max (α) is 64. For this example, the preset ratios are

1:16, 1:32 and 1:64, and then the value

$$\frac{i}{max ( α )}$$

(from EQ. 1b) for each of the preset ratios is:

$$\frac{i}{max ( α )} = \{ \frac{16}{64} , \frac{32}{64} , \frac{64}{64} \} = \{ 0.25 , 0.5 , 1 \} \qquad EQ . 1 c$$

Assuming for one example that the factor (EQ. 1a) is 1 (meaning stability is high), then the distance=0 when considering a ratio of 1:64. In such case, the selected downscaling ratio (resolution) is 1:64. Other formulae can be used for selecting the best resolution.

From the above formulae, several conclusions are drawn: (A) When the stability score falls into the range (0.4, 1], the factor gradient is small, indicating the current scene is relatively steady. Thus, for this first example scenario the scene similarity analyzer and 3A algorithms can use low resolution statistics. (B) When the stability score falls into the range [0, 0.4], the factor gradient is large, indicating the current scene is relatively unstable. Thus, for this second example scenario the scene similarity analyzer and 3A algorithms need to use high resolution statistics. (C) When the stability score is close to 1, this indicates the current scene is stable (e.g., almost frozen), so for this third example scenario the lowest resolution statistics are used (e.g., the statistics corresponding to the lowest resolution of the predetermined set of resolutions). (D) When the stability score is close to 0, this indicates the scene changes a lot (e.g., relatively highly unstable), so for this fourth example scenario the highest resolution statistics are used (e.g., the statistics corresponding to the highest resolution of the predetermined set of resolutions).

Illustrated processing block 24 (labeled P4) provides for calculating AWB results (e.g., AWB parameters) based on statistics—which were previously generated—corresponding to the selected (target) resolution. Illustrated processing block 25 (labeled P5) provides for calculating AE results (e.g., AE parameters) based on the previously generated statistics corresponding to the selected (target) resolution. In some embodiments, the adaptive method 20B further includes calculating AF results (e.g., AF parameters) based on the previously generated statistics corresponding to the selected (target) resolution.

Some or all features or operations relating to the method 20B can be implemented using one or more of a central processing unit (CPU), a graphics processing unit (GPU), an artificial intelligence (AI) accelerator, a field programmable gate array (FPGA) accelerator, an application specific integrated circuit (ASIC), and/or via a processor with software, or in a combination of a processor with software and an FPGA or ASIC. More particularly, the method 20B can be implemented in one or more modules as a set of program or logic instructions stored in a machine- or computer-readable storage medium such as random access memory (RAM), read only memory (ROM), programmable ROM (PROM), firmware, flash memory, etc., in hardware, or any combination thereof. For example, hardware implementations can include configurable logic, fixed-functionality logic, or any combination thereof. Examples of configurable logic include suitably configured programmable logic arrays (PLAs), FPGAs, complex programmable logic devices (CPLDs), and general purpose microprocessors. Examples of fixed-functionality logic include suitably configured ASICs, combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

For example, computer program code to carry out the method 20B can be written in any combination of one or more programming languages, including an object oriented programming language such as Java, JavaScript, Python, C#, C++, Perl, Smalltalk, or the like and conventional procedural programming languages, such as the “C” programming language or similar programming languages. Additionally, program or logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

FIG. 2C provides a diagram illustrating an example simulated curve 29 for a formula to select among preset resolutions according to one or more embodiments, with reference to components and features described herein including but not limited to the figures and associated description. The x-axis represents values of a stability score (e.g., in the range of 0 to 1), and the y-axis represents the factor according to EQ. 1a (e.g., in the range of −0.4 to 1). The example simulated curve is in effect a combination of two curves represented by the equations in EQ. 1a.

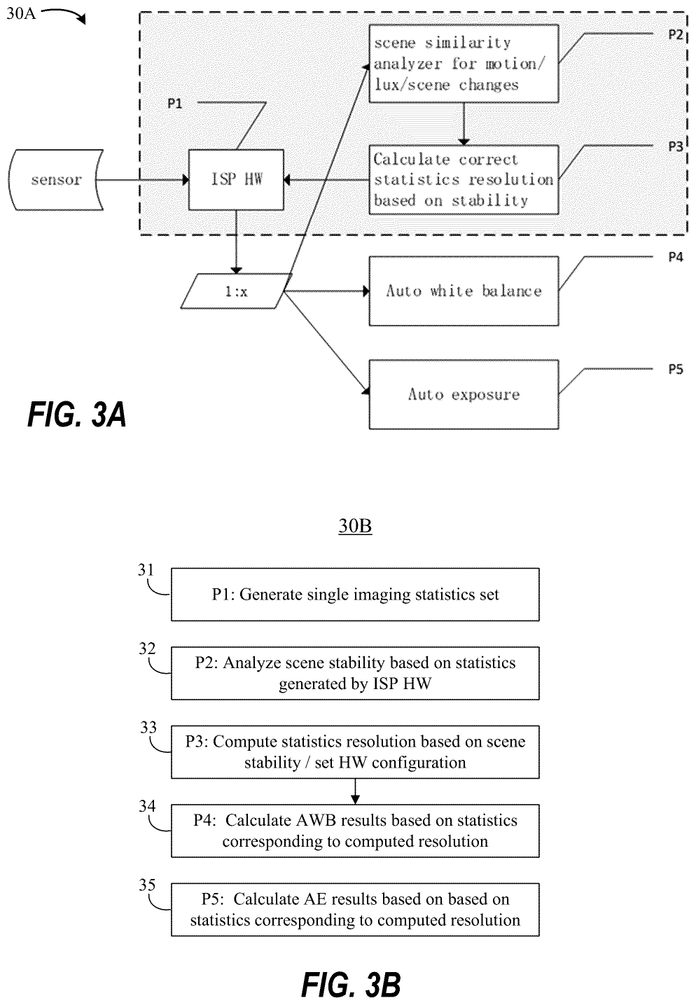

FIGS. 3A-3B provide diagrams illustrating an alternative adaptive technique to determine an imaging statistics resolution for use in determining 3A statistics for computing 3A algorithms according to one or more embodiments, with reference to components and features described herein including but not limited to the figures and associated description. As shown in FIG. 3A, the diagram illustrates an adaptive technique 30A to determine an imaging statistics resolution to be used in determining 3A statistics when running 3A algorithms. The adaptive technique 30A operates by computing a target imaging statistics resolution based on scene stability and generating imaging statistics corresponding to the target resolution. An imaging sensor (e.g., an imaging device or part of a camera/imaging device) provides input images to the ISP hardware, which operates to generate a set of imaging statistics based on a statistics resolution (e.g., a resolution used in the prior iteration of the process). A scene stability analysis is conducted to determine a scene stability score (e.g., as described herein with reference to FIGS. 2A-B). The scene stability score is used to calculate the target statistics resolution. The ISP hardware then generates imaging statistics at the determined (target) resolution which are used by the 3A algorithms to calculate one or more of the AE, AWB and/or AF parameters for the camera imaging device.

Turning now to FIG. 3B, the diagram illustrates an adaptive method 30B to determine an imaging statistics resolution and generate imaging statistics for calculating AE/AWB parameters for the technique illustrated in FIG. 3A. The adaptive method 30B includes five illustrated processing blocks labeled P1 through P5 that correspond to labels P1 through P5 in FIG. 3A. A core portion of the method 30B (processing blocks labeled P1, P2 and P3) corresponds to three labels P1-P3 shown in the shaded block of FIG. 3A.

Illustrated processing block 31 (labeled P1) provides for initializing the ISP hardware with a default statistics resolution configuration to generate a single set of statistics. In embodiments, the statistics resolution is based on computed in a prior iteration of processing block 33. Taking the RAW image from the imaging sensor as input, the ISP hardware (e.g., the 3A statistics module 14 in FIG. 1, already discussed) generates a single set of statistics.

Illustrated processing block 32 (labeled P2) provides for analyzing scene stability based on statistics generated by the ISP hardware. In embodiments, the statistics used in scene stability analysis are based on a statistics resolution computed in a prior iteration of processing block 33. A scene similarity analysis algorithm (e.g., the scene similarity analysis algorithm as described herein with reference to FIG. 2B) analyzes the scenes from the recent history (e.g., current frame and previous frame, past two frames, or past several frames, etc.) and calculates a stability score that reflects a relative stability for the scene.

Illustrated processing block 33 (labeled P3) provides for computing the best (target) statistics resolution based on scene stability, and then set the ISP hardware configuration to generate statistics at the calculated target resolution. Based on the stability score from block 32 (P2), the best statistics resolution (downscaling ratio) is calculated as the target resolution. Then, the corresponding configuration using the target resolution is set in the ISP hardware to generate the target statistics. When the scene changes a lot, the process at block 32 (P2) should detect those changes and regenerate a lower stability score (e.g., the score could change from 0.8 to 0.2). Then, block 33 (P3) should recalculate higher resolution for the ISP hardware settings according to scene changing level. In embodiments, the statistics resolution (e.g., downscaling ratio) to be used in block 32 (P2) is updated based on the computation. That is, the next iteration of block 32 (P2) uses updated ratio scaled statistics (e.g., the selected statistics corresponding to the computed resolution) to calculate the stability score. The suggested formula is:

$$factor = \{ \begin{matrix}k * log ( score ) + a & when 0. < score \leq 0.4 \\ {score}^{γ} - δ & when 0.4 < score \leq 1.\end{matrix} \qquad EQ . 2 a$$

$$ratio = M * max ( \frac{1}{factor} , 1 ) \qquad EQ . 2 b$$

where:
ratio represents a target statistics downscaling ratio (target resolution), can be used as an input parameter for ISP hardware
score represents a stability score (normalized between 0 and 1)
γ represents a tuning parameter (e.g. 0.2)
δ represents a conjunction of 2 curves
M represents a maximum scaling ratio supported by the IPU/ISP

EQ. 2a is the same as EQ. 1a, and the values of a, k, δ and γ are set as described above with reference to EQ. 1a. As an example for the parameter M in EQ. 2b, in an embodiment where the IPU/ISP supports only resolutions from 1:16 to 1:64 (inclusive), then the parameter M is 1/64. Once the target statistics resolution is computed (EQ. 2b), the target resolution is passed to the ISP hardware to generate statistics at the target resolution. Other formulae can be used for calculating the best/target resolution.

Illustrated processing block 34 (labeled P4) provides for calculating AWB results (e.g., AWB parameters) based on statistics generated at the calculated resolution. Illustrated processing block 35 (labeled P5) provides for calculating AE results (e.g., AE parameters) based on the statistics generated at the computed resolution. In some embodiments, the adaptive method 30B further includes calculating AF results (e.g., AF parameters) based on the statistics generated at the calculated resolution.

Some or all features or operations relating to the method 30B can be implemented using one or more of a CPU, a GPU, an AI accelerator, an FPGA accelerator, an ASIC, and/or via a processor with software, or in a combination of a processor with software and an FPGA or ASIC. More particularly, the method 30B can be implemented as one or more modules as a set of logic instructions stored in a machine- or computer-readable storage medium such as RAM, ROM, PROM, firmware, flash memory, etc., in hardware, or any combination thereof. For example, hardware implementations can include configurable logic, fixed-functionality logic, or any combination thereof. Examples of configurable logic include suitably configured PLAs, FPGAs, CPLDs, and general purpose microprocessors. Examples of fixed-functionality logic include suitably configured ASICs, combinational logic circuits, and sequential logic circuits. The configurable or fixed-functionality logic can be implemented with CMOS logic circuits, TTL logic circuits, or other circuits.

For example, computer program code to carry out the method 30B can be written in any combination of one or more programming languages, including an object oriented programming language such as Java, JavaScript, Python, C#, C++, Perl, Smalltalk, or the like and conventional procedural programming languages, such as the “C” programming language or similar programming languages. Additionally, program or logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

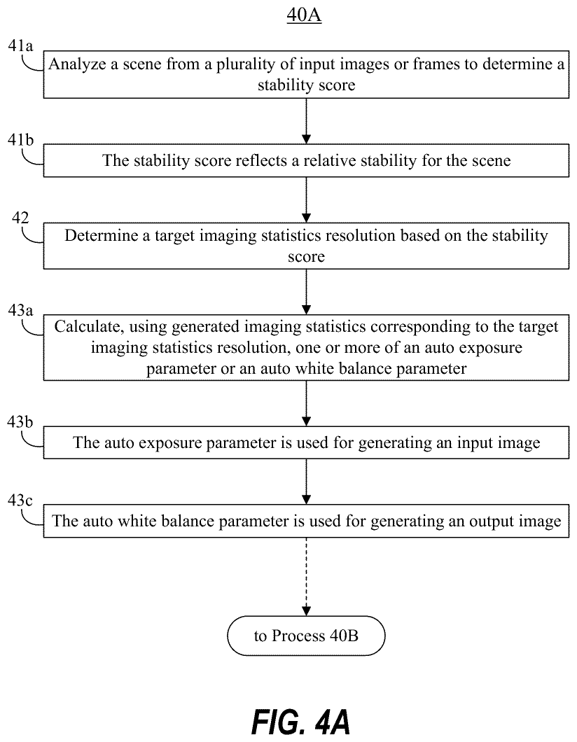

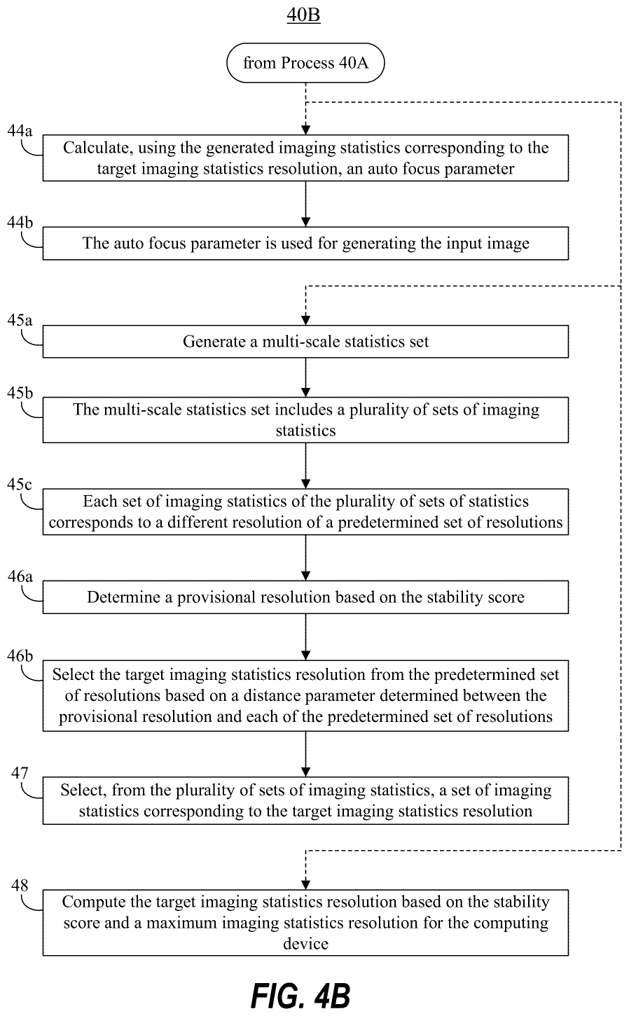

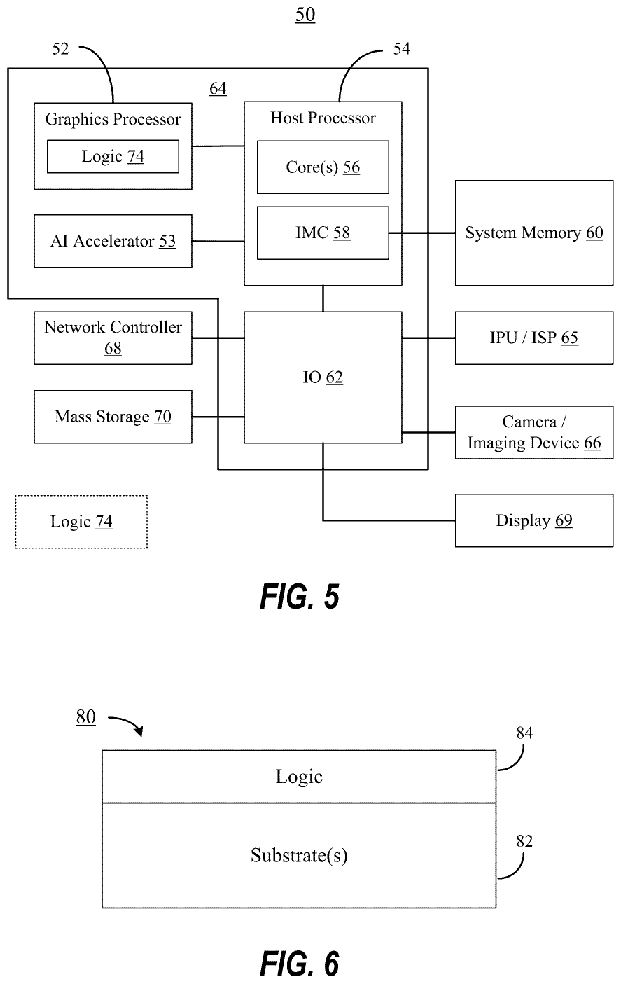

FIGS. 4A-B provide flow diagrams illustrating an example method 40 (including process components 40A and 40B) of determining auto exposure and auto white balance parameters for generating an output image according to one or more embodiments, with reference to components and features described herein including but not limited to the figures and associated description. The method 40 can generally be implemented in a computing device such as, e.g., the system 50 described herein with reference to FIG. 5. More particularly, the method 40 can be implemented as one or more modules as a set of logic instructions stored in a machine- or computer-readable storage medium such as RAM, ROM, PROM, firmware, flash memory, etc., in hardware, or any combination thereof. For example, hardware implementations can include configurable logic, fixed-functionality logic, or any combination thereof. Examples of configurable logic include suitably configured PLAs, FPGAs, CPLDs, and general purpose microprocessors. Examples of fixed-functionality logic include suitably configured ASICs, combinational logic circuits, and sequential logic circuits. The configurable or fixed-functionality logic can be implemented with CMOS logic circuits, TTL logic circuits, or other circuits.

For example, computer program code to carry out operations in the method 40 can be written in any combination of one or more programming languages, including an object oriented programming language such as Java, JavaScript, Python, C#, C++, Perl, Smalltalk, or the like and conventional procedural programming languages, such as the “C” programming language or similar programming languages. Additionally, program or logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Turning to FIG. 4A, illustrated processing block 41a provides for analyzing a scene from a plurality of input images (e.g., a plurality of recent images or frames) to determine a stability score, where at block 41b the stability score reflects a relative stability for the scene. Illustrated processing block 42 provides for determining a target imaging statistics resolution based on the stability score. Illustrated processing block 43a provides for calculating, using generated imaging statistics corresponding to the target imaging statistics resolution, one or more of an auto exposure parameter or an auto white balance parameter, where at block 43b the auto exposure parameter is used for generating an input image, and where at block 43c the auto white balance parameter is used for generating an output image.

Turning now to FIG. 4B, in some embodiments illustrated processing block 44a provides for calculating, using the generated imaging statistics corresponding to the target imaging statistics resolution, an auto focus parameter, where at block 44b the auto focus parameter is used for generating the input image.

In some embodiments, illustrated processing block 45a provides for generating a multi-scale statistics set, where at block 45b the multi-scale statistics set includes a plurality of sets of imaging statistics, and where at block 45c each set of imaging statistics of the plurality of sets of imaging statistics corresponds to a different resolution of a predetermined set of resolutions. In some embodiments, determining the target imaging statistics resolution based on the stability score includes, at illustrated processing block 46a, determining a provisional resolution based on the stability score and, at illustrated processing block 46b, selecting the target imaging statistics resolution from the predetermined set of resolutions based on a distance parameter determined between the provisional resolution and each of the predetermined set of resolutions. Thus in some embodiments processing blocks 46a and 46b can be substituted for all or a portion of processing block 42 (FIG. 4A, already discussed).

In some embodiments, using the generated imaging statistics corresponding to the target imaging statistics resolution includes, at illustrated processing block 47, selecting, from the plurality of sets of imaging statistics, a set of imaging statistics corresponding to the target imaging statistics resolution. In some embodiments, the predetermined set of resolutions include a first resolution corresponding to a downscaling ratio of 1:64, a second resolution corresponding to a downscaling ratio of 1:32, and a third resolution corresponding to a downscaling ratio of 1:16.

In some embodiments, determining the target imaging statistics resolution based on the stability score includes, at illustrated processing block 48, computing the target imaging statistics resolution based on the stability score and a maximum imaging statistics resolution for the computing device.

In some embodiments, when the relative stability for the scene is high the target imaging statistics resolution is a fourth resolution, and when the relative stability for the scene is low the target imaging statistics resolution is a fifth resolution, where the fifth resolution is higher than the fourth resolution.

FIG. 5 is a block diagram of an example of a performance-enhanced computing system 50 according to one or more embodiments. The performance-enhanced computing system 50 that may generally be part of an electronic device/system having computing functionality (e.g., personal digital assistant/PDA, notebook computer, tablet computer, convertible tablet, server), communications functionality (e.g., smartphone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), etc., or any combination thereof. In the illustrated example, the system 50 includes one or more of a graphics processor 52 (e.g., graphics processing unit/GPU) and/or a host processor 54 (e.g., central processing unit/CPU) having one or more cores 56 and an integrated memory controller (IMC) 58 that is coupled to a system memory 60. The system memory 60 can include any non-transitory machine- or computer-readable storage medium such as RAM, ROM, PROM, EEPROM, firmware, flash memory, etc., configurable logic such as, for example, PLAs, FPGAs, CPLDs, fixed-functionality hardware logic using circuit technology such as, for example, ASIC, CMOS or TTL technology, or any combination thereof suitable for storing instructions and/or data used in performing some or all of the operations and/or functions as described herein with reference to the method 20B, the method 30B, and/or the method 40.

Additionally, the illustrated system 50 includes an input output (IO) module 62. In embodiments the IO module 62 is implemented together with the host processor 54 and/or the graphics processor 52 on a system on chip (SoC) 64 (e.g., semiconductor die).

An IPU/ISP 65 (e.g., an IPU/ISP as described herein with reference to FIGS. 1, 2A, 2B, 3A, 3B, 4A and/or 4B) is coupled to the GPU 52 and/or the host processor 54—e.g., via the IO module 62 which communicates with the IPU/ISP 65. A camera/imaging device 66 (e.g., a camera/imaging device as described herein with reference to FIGS. 1, 2A, 2B, 3A, 3B, 4A and/or 4B) is also coupled to the GPU 52 and/or the host processor 54—e.g., via the IO module 62 which communicates with the camera/imaging device 66. The camera/imaging device 66 is in embodiments an imaging sensor. In some embodiments, the IPU/ISP 65 is incorporated within the camera/imaging device 66. In some embodiments, the IPU/ISP 65 and/or the camera/imaging device 66 (or some/all features or functions thereof) is/are incorporated within other components of the system 50.

In embodiments, the IO module 62 communicates with a display 69 (e.g., touch screen, liquid crystal display/LCD, light emitting diode/LED display), a network controller 68 (e.g., wired and/or wireless), and/or mass storage 70 (e.g., hard disk drive/HDD, optical disk, solid state drive/SSD, flash memory). The mass storage 70 is suitable for storing instructions and/or data used in performing some or all of the operations and/or functions as described herein with reference to the method 20B, the method 30B, and/or the method 40.

In embodiments, the graphics processor 52 includes logic 74 (e.g., logic instructions, configurable logic, fixed-functionality hardware logic, etc., or any combination thereof) to perform some or all of the operations and/or functions as described herein with reference to the method 20B, the method 30B, and/or the method 40. Although the logic 74 is shown in the graphics processor 52, the logic 74 may be located elsewhere in the computing system 50. In some embodiments, the system 50 also includes an AI accelerator 53. In an embodiment, the system 50 can also include a vision processing unit (VPU), not shown.

Accordingly, the system 50 can implement all or portions of the features, functions and/or operations described herein with reference to FIGS. 2A, 2B, 3A, 3B, 4A and/or 4B. The system 50 can also implement features, functions and/or operations described herein with reference to FIG. 1. The system 50 can also perform some or all of the operations and/or functions as described herein with reference to the method 20B, the method 30B, and/or the method 40.

The SoC 64 may include one or more substrates (e.g., silicon, sapphire, gallium arsenide), wherein the logic 74 is a transistor array and/or other integrated circuit/IC components coupled to the substrate(s). In one example, the logic 74 includes transistor channel regions that are positioned (e.g., embedded) within the substrate(s). Thus, the physical interface between the logic 74 and the substrate(s) may not be an abrupt junction. The logic 74 may also be considered to include an epitaxial layer that is grown on an initial wafer of the substrate(s).

FIG. 6 is a block diagram illustrating an example semiconductor apparatus 80 according to one or more embodiments, with reference to components and features described herein including but not limited to the figures and associated description. The semiconductor apparatus 80 can be implemented, e.g., as a chip, die, or other semiconductor package. The semiconductor apparatus 80 can include one or more substrates 82 comprised of, e.g., silicon, sapphire, gallium arsenide, etc. The semiconductor apparatus 80 can also include logic 84 comprised of, e.g., transistor array(s) and other integrated circuit (IC) components) coupled to the substrate(s) 82. The logic 84 can be implemented at least partly in configurable logic or fixed-functionality logic hardware. The logic 84 can implement the system on chip (SoC) 64 and/or other portions of the system 50 (or components thereof) described above with reference to FIG. 5. The logic 84 can implement one or more aspects of the processes described above, including the method 20B, the method 30B, and/or the method 40.

The semiconductor apparatus 80 can be constructed using any appropriate semiconductor manufacturing processes or techniques. For example, the logic 84 can include transistor channel regions that are positioned (e.g., embedded) within the substrate(s) 82. Thus, the interface between the logic 84 and the substrate(s) 82 may not be an abrupt junction. The logic 84 can also be considered to include an epitaxial layer that is grown on an initial wafer of the substrate(s) 82.

Embodiments of each of the above systems, devices, components, features and/or methods, including the adaptive technique 20A, the method 20B, the adaptive technique 30A, the method 30B, the method 40 and/or the system 50, and/or any other system components, can be implemented in hardware, software, or any suitable combination thereof. For example, hardware implementations can include configurable logic, fixed-functionality logic, or any combination thereof. Examples of configurable logic include suitably configured PLAs, FPGAs, CPLDs, and general purpose microprocessors. Examples of fixed-functionality logic include suitably configured ASICs, combinational logic circuits, and sequential logic circuits. The configurable or fixed-functionality logic can be implemented with CMOS logic circuits, TTL logic circuits, or other circuits.

Alternatively, or additionally, all or portions of the foregoing systems, devices, components, features and/or methods can be implemented in one or more modules as a set of program or logic instructions stored in a machine- or computer-readable storage medium such as RAM, ROM, PROM, firmware, flash memory, etc., to be executed by a processor or computing device. For example, computer program code to carry out the operations of the components can be written in any combination of one or more operating system (OS) applicable/appropriate programming languages, including an object-oriented programming language such as Java, JavaScript, Python, C#, C++, Perl, Smalltalk, or the like and conventional procedural programming languages, such as the “C” programming language or similar programming languages.

### Additional Notes and Examples

Example S1 includes a performance-enhanced computing system comprising a processor, an imaging device coupled to the processor, and memory coupled to the processor, the memory to store instructions which, when executed by the processor, cause the computing system to analyze a scene from a plurality of input images to determine a stability score, wherein the stability score reflects a relative stability for the scene, determine a target imaging statistics resolution based on the stability score, and calculate, using generated imaging statistics corresponding to the target imaging statistics resolution, one or more of an auto exposure parameter or an auto white balance parameter, wherein the auto exposure parameter is to be used for generating an input image and the auto white balance parameter is to be used for generating an output image.

Example S2 includes the computing system of Example S1, wherein the instructions, when executed, cause the computing system to generate a multi-scale statistics set, the multi-scale statistics set including a plurality of sets of imaging statistics, each set of imaging statistics of the plurality of sets of imaging statistics corresponding to a different resolution of a predetermined set of resolutions, wherein to determine the target imaging statistics resolution based on the stability score, the instructions, when executed, cause the computing system to determine a provisional resolution based on the stability score, and select the target imaging statistics resolution from the predetermined set of resolutions based on a distance parameter determined between the provisional resolution and each of the predetermined set of resolutions.

Example S3 includes the computing system of Example S1 or S2, wherein using the generated imaging statistics corresponding to the target imaging statistics resolution comprises selecting, from the plurality of sets of imaging statistics, a set of imaging statistics corresponding to the target imaging statistics resolution.

Example S4 includes the computing system of Example S1, S2 or S3, wherein the predetermined set of resolutions include a first resolution corresponding to a downscaling ratio of 1:64, a second resolution corresponding to a downscaling ratio of 1:32, and a third resolution corresponding to a downscaling ratio of 1:16.

Example S5 includes the computing system of any of Examples S1-S4, wherein to determine the target imaging statistics resolution based on the stability score, the instructions, when executed, cause the computing system to compute the target imaging statistics resolution based on the stability score and a maximum imaging statistics resolution for the computing system.

Example S6 includes the computing system of any of Examples S1-S5, wherein the instructions, when executed, cause the computing system to calculate, using the generated imaging statistics corresponding to the target imaging statistics resolution, an auto focus parameter, wherein the auto focus parameter is used for generating the input image.

Example S7 includes the computing system of any of Examples S1-S6, wherein the stability score is to be determined based on comparing imaging statistics for two images in a sequence.

Example A1 includes a semiconductor apparatus comprising one or more substrates, and logic coupled to the one or more substrates, wherein the logic is implemented at least partly in one or more of configurable logic or fixed-functionality hardware logic, the logic to analyze a scene from a plurality of input images to determine a stability score, wherein the stability score reflects a relative stability for the scene, determine a target imaging statistics resolution based on the stability score, and calculate, using generated imaging statistics corresponding to the target imaging statistics resolution, one or more of an auto exposure parameter or an auto white balance parameter, wherein the auto exposure parameter is to be used for generating an input image and the auto white balance parameter is to be used for generating an output image.

Example A2 includes the apparatus of Example A1, wherein the logic is to generate a multi-scale statistics set, the multi-scale statistics set including a plurality of sets of imaging statistics, each set of imaging statistics of the plurality of sets of imaging statistics corresponding to a different resolution of a predetermined set of resolutions, wherein to determine the target imaging statistics resolution based on the stability score, the logic is to determine a provisional resolution based on the stability score, and select the target imaging statistics resolution from the predetermined set of resolutions based on a distance parameter determined between the provisional resolution and each of the predetermined set of resolutions.

Example A3 includes the apparatus of Example A1 or A2, wherein using the generated imaging statistics corresponding to the target imaging statistics resolution comprises selecting, from the plurality of sets of imaging statistics, a set of imaging statistics corresponding to the target imaging statistics resolution.

Example A4 includes the apparatus of Example A1, A2 or A3, wherein the predetermined set of resolutions include a first resolution corresponding to a downscaling ratio of 1:64, a second resolution corresponding to a downscaling ratio of 1:32, and a third resolution corresponding to a downscaling ratio of 1:16.

Example A5 includes the apparatus of any of Examples A1-A4, wherein to determine the target imaging statistics resolution based on the stability score, the logic is to compute the target imaging statistics resolution based on the stability score and a maximum imaging statistics resolution for the apparatus.

Example A6 includes the apparatus of any of Examples A1-A5, wherein the logic is to calculate, using the generated imaging statistics corresponding to the target imaging statistics resolution, an auto focus parameter, wherein the auto focus parameter is used for generating the input image.

Example A7 includes the apparatus of any of Examples A1-A6, wherein the stability score is to be determined based on comparing imaging statistics for two images in a sequence.

Example C1 includes at least one computer readable storage medium comprising a set of executable program instructions which, when executed by a computing device, cause the computing device to analyze a scene from a plurality of input images to determine a stability score, wherein the stability score reflects a relative stability for the scene, determine a target imaging statistics resolution based on the stability score, and calculate, using generated imaging statistics corresponding to the target imaging statistics resolution, one or more of an auto exposure parameter or an auto white balance parameter, wherein the auto exposure parameter is used for generating an input image and the auto white balance parameter is used for generating an output image.

Example C2 includes the at least one computer readable storage medium of Example C1, wherein the instructions, when executed, cause the computing device to generate a multi-scale statistics set, the multi-scale statistics set including a plurality of sets of imaging statistics, each set of imaging statistics of the plurality of sets of imaging statistics corresponding to a different resolution of a predetermined set of resolutions, wherein to determine the target imaging statistics resolution based on the stability score, the instructions, when executed, cause the computing device to determine a provisional resolution based on the stability score, and select the target imaging statistics resolution from the predetermined set of resolutions based on a distance parameter determined between the provisional resolution and each of the predetermined set of resolutions.

Example C3 includes the at least one computer readable storage medium of Example C1 or C2, wherein using the generated imaging statistics corresponding to the target imaging statistics resolution comprises selecting, from the plurality of sets of imaging statistics, a set of imaging statistics corresponding to the target imaging statistics resolution.

Example C4 includes the at least one computer readable storage medium of Example C 1, C2 or C3, wherein the predetermined set of resolutions include a first resolution corresponding to a downscaling ratio of 1:64, a second resolution corresponding to a downscaling ratio of 1:32, and a third resolution corresponding to a downscaling ratio of 1:16.

Example C5 includes the at least one computer readable storage medium of any of Examples C1-C4, wherein to determine the target imaging statistics resolution based on the stability score, the instructions, when executed, cause the computing device to compute the target imaging statistics resolution based on the stability score and a maximum imaging statistics resolution for the computing device.

Example C6 includes the at least one computer readable storage medium of any of Examples C1-C5, wherein the instructions, when executed, cause the computing device to calculate, using the generated imaging statistics corresponding to the target imaging statistics resolution, an auto focus parameter, wherein the auto focus parameter is used for generating the input image.

Example C7 includes the at least one computer readable storage medium of any of Examples C1-C6, wherein the stability score is to be determined based on comparing imaging statistics for two images in a sequence.

Example M1 includes a method comprising analyzing a scene from a plurality of input images to determine a stability score, wherein the stability score reflects a relative stability for the scene, determining a target imaging statistics resolution based on the stability score, and calculating, using generated imaging statistics corresponding to the target imaging statistics resolution, one or more of an auto exposure parameter or an auto white balance parameter, wherein the auto exposure parameter is used for generating an input image and the auto white balance parameter is used for generating an output image.

Example M2 includes the method of Example M1, further comprising generating a multi-scale statistics set, the multi-scale statistics set including a plurality of sets of imaging statistics, each set of imaging statistics of the plurality of sets of imaging statistics corresponding to a different resolution of a predetermined set of resolutions, wherein determining the target imaging statistics resolution based on the stability score comprises determining a provisional resolution based on the stability score, and selecting the target imaging statistics resolution from the predetermined set of resolutions based on a distance parameter determined between the provisional resolution and each of the predetermined set of resolutions.

Example M3 includes the method of Example M1 or M2, wherein using the generated imaging statistics corresponding to the target imaging statistics resolution comprises selecting, from the plurality of sets of imaging statistics, a set of imaging statistics corresponding to the target imaging statistics resolution.

Example M4 includes the method of Example M1, M2 or M3, wherein the predetermined set of resolutions include a first resolution corresponding to a downscaling ratio of 1:64, a second resolution corresponding to a downscaling ratio of 1:32, and a third resolution corresponding to a downscaling ratio of 1:16.

Example M5 includes the method of any of Examples M1-M4, wherein determining the target imaging statistics resolution based on the stability score comprises computing the target imaging statistics resolution based on the stability score and a maximum imaging statistics resolution for the computing device.

Example M6 includes the method of any of Examples M1-M5, further comprising calculating, using the generated imaging statistics corresponding to the target imaging statistics resolution, an auto focus parameter, wherein the auto focus parameter is used for generating the input image.

Example M7 includes the method of any of Examples M1-M6, wherein the stability score is determined based on comparing imaging statistics for two images in a sequence.

Example MA1 includes an apparatus comprising means for performing the method of any of Examples M1 to M7.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections, including logical connections via intermediate components (e.g., device A may be coupled to device C via device B). In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A, B, C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing system comprising:
a processor;
an imaging device coupled to the processor; and
memory coupled to the processor, the memory to store instructions which, when executed by the processor, cause the computing system to:
analyze a scene from a plurality of input images to determine a stability score, wherein the stability score reflects a relative stability for the scene;
determine a target imaging statistics resolution based on the stability score; and
calculate, using generated imaging statistics corresponding to the target imaging statistics resolution, one or more of an auto exposure parameter or an auto white balance parameter, wherein the auto exposure parameter is to be used for generating an input image and the auto white balance parameter is to be used for generating an output image.

2. The computing system of claim 1, wherein the instructions, when executed, cause the computing system to generate a multi-scale statistics set, the multi-scale statistics set including a plurality of sets of imaging statistics, each set of imaging statistics of the plurality of sets of imaging statistics corresponding to a different resolution of a predetermined set of resolutions;
wherein to determine the target imaging statistics resolution based on the stability score, the instructions, when executed, cause the computing system to:
determine a provisional resolution based on the stability score; and
select the target imaging statistics resolution from the predetermined set of resolutions based on a distance parameter determined between the provisional resolution and each of the predetermined set of resolutions.

3. The computing system of claim 2, wherein using the generated imaging statistics corresponding to the target imaging statistics resolution comprises selecting, from the plurality of sets of imaging statistics, a set of imaging statistics corresponding to the target imaging statistics resolution.

4. The computing system of claim 3, wherein the predetermined set of resolutions include a first resolution corresponding to a downscaling ratio of 1:64, a second resolution corresponding to a downscaling ratio of 1:32, and a third resolution corresponding to a downscaling ratio of 1:16.

5. The computing system of claim 1, wherein to determine the target imaging statistics resolution based on the stability score, the instructions, when executed, cause the computing system to compute the target imaging statistics resolution based on the stability score and a maximum imaging statistics resolution for the computing system.

6. The computing system of claim 1, wherein the instructions, when executed, cause the computing system to calculate, using the generated imaging statistics corresponding to the target imaging statistics resolution, an auto focus parameter, wherein the auto focus parameter is used for generating the input image.

7. The computing system of claim 1, wherein the stability score is to be determined based on comparing imaging statistics for two images in a sequence.

8. A semiconductor apparatus comprising:
one or more substrates; and
logic coupled to the one or more substrates, wherein the logic is implemented at least partly in one or more of configurable logic or fixed-functionality hardware logic, the logic to:
analyze a scene from a plurality of input images to determine a stability score, wherein the stability score reflects a relative stability for the scene;
determine a target imaging statistics resolution based on the stability score; and
calculate, using generated imaging statistics corresponding to the target imaging statistics resolution, one or more of an auto exposure parameter or an auto white balance parameter, wherein the auto exposure parameter is to be used for generating an input image and the auto white balance parameter is to be used for generating an output image.

9. The apparatus of claim 8, wherein the logic is to generate a multi-scale statistics set, the multi-scale statistics set including a plurality of sets of imaging statistics, each set of imaging statistics of the plurality of sets of imaging statistics corresponding to a different resolution of a predetermined set of resolutions;
wherein to determine the target imaging statistics resolution based on the stability score, the logic is to:
determine a provisional resolution based on the stability score; and
select the target imaging statistics resolution from the predetermined set of resolutions based on a distance parameter determined between the provisional resolution and each of the predetermined set of resolutions.

10. The apparatus of claim 9, wherein using the generated imaging statistics corresponding to the target imaging statistics resolution comprises selecting, from the plurality of sets of imaging statistics, a set of imaging statistics corresponding to the target imaging statistics resolution.

11. The apparatus of claim 10, wherein the predetermined set of resolutions include a first resolution corresponding to a downscaling ratio of 1:64, a second resolution corresponding to a downscaling ratio of 1:32, and a third resolution corresponding to a downscaling ratio of 1:16.

12. The apparatus of claim 8, wherein to determine the target imaging statistics resolution based on the stability score, the logic is to compute the target imaging statistics resolution based on the stability score and a maximum imaging statistics resolution for the apparatus.

13. The apparatus of claim 8, wherein the logic is to calculate, using the generated imaging statistics corresponding to the target imaging statistics resolution, an auto focus parameter, wherein the auto focus parameter is used for generating the input image, and wherein the stability score is to be determined based on comparing imaging statistics for two images in a sequence.

14. At least one computer readable storage medium comprising a set of executable program instructions which, when executed by a computing device, cause the computing device to:
analyze a scene from a plurality of input images to determine a stability score, wherein the stability score reflects a relative stability for the scene;
determine a target imaging statistics resolution based on the stability score; and
calculate, using generated imaging statistics corresponding to the target imaging statistics resolution, one or more of an auto exposure parameter or an auto white balance parameter, wherein the auto exposure parameter is used for generating an input image and the auto white balance parameter is used for generating an output image.

15. The at least one computer readable storage medium of claim 14, wherein the instructions, when executed, cause the computing device to generate a multi-scale statistics set, the multi-scale statistics set including a plurality of sets of imaging statistics, each set of imaging statistics of the plurality of sets of imaging statistics corresponding to a different resolution of a predetermined set of resolutions;
wherein to determine the target imaging statistics resolution based on the stability score, the instructions, when executed, cause the computing device to:
determine a provisional resolution based on the stability score; and
select the target imaging statistics resolution from the predetermined set of resolutions based on a distance parameter determined between the provisional resolution and each of the predetermined set of resolutions.

16. The at least one computer readable storage medium of claim 15, wherein using the generated imaging statistics corresponding to the target imaging statistics resolution comprises selecting, from the plurality of sets of imaging statistics, a set of imaging statistics corresponding to the target imaging statistics resolution.

17. The at least one computer readable storage medium of claim 16, wherein the predetermined set of resolutions include a first resolution corresponding to a downscaling ratio of 1:64, a second resolution corresponding to a downscaling ratio of 1:32, and a third resolution corresponding to a downscaling ratio of 1:16.

18. The at least one computer readable storage medium of claim 14, wherein to determine the target imaging statistics resolution based on the stability score, the instructions, when executed, cause the computing device to compute the target imaging statistics resolution based on the stability score and a maximum imaging statistics resolution for the computing device.

19. The at least one computer readable storage medium of claim 14, wherein the instructions, when executed, cause the computing device to calculate, using the generated imaging statistics corresponding to the target imaging statistics resolution, an auto focus parameter, wherein the auto focus parameter is used for generating the input image.

20. The at least one computer readable storage medium of claim 14, wherein the stability score is to be determined based on comparing imaging statistics for two images in a sequence.
